(19) United States
(12) Patent Application Publication
(10) Pub. No.: US 2024/0169451 A1
(43) Pub. Date: May 23, 2024

(54) SYSTEM AND METHOD FOR MONITORING CONVERSIONS ATTRIBUTION TO SOCIAL MEDIA ACTIVITIES

(71) Applicant: Agorapulse SAS, Paris (FR)

(72) Inventor: Emeric Ernoult, Croissy-sur-Seine (FR)

(73) Assignee: Agorapulse SAS, Paris (FR)

(21) Appl. No.: 18/512,718

(22) Filed: Nov. 17, 2023

Related U.S. Application Data
(60) Provisional application No. 63/426,696, filed on Nov. 18, 2022.

(51) Int. Cl. G06Q 50/00

(52) U.S. Cl. CPC G06Q 50/01

(57) ABSTRACT

A method for tracking a business impact of social media campaigns includes identifying or receiving a link to be shared in social media content. The method further includes generating a unique identifier to be associated with the social media content. The method further includes creating a trackable link by adding information corresponding to the unique identifier to the link. The method further includes inserting the trackable link into the social media content. The method further includes sharing the social media content with the trackable link on a social media platform. The method further includes retrieving impact data corresponding to a business impact of the social media content, the stored impact data being associated with the unique identifier. The method further includes generating a return on investment report (ROI report) by aggregating the impact data into a predetermined format. The method further includes outputting the ROI report.

### CROSS-REFERENCE TO RELATED APPLICATIONS

This application claims the benefit and priority of U.S. Provisional Application No. 63/426,696, titled SYSTEM AND METHOD FOR MONITORING CONVERSIONS ATTRIBUTION TO SOCIAL MEDIA ACTIVITIES and filed Nov. 18, 2022, the entire disclosure of which being expressly incorporated by reference herein in its entirety.

### BACKGROUND

### Field

The present disclosure is directed to systems and methods that allow businesses and other entities to efficiently utilize social media channels and, more particularly, that allow businesses to measure business impacts of social media content including web traffic, lead conversions, and revenues, thus increasing ability of the entity to create and share content that is likely to increase business generation.

### Description of the Related Art

Social media platforms (e.g., Facebook®, LinkedIn®, Instagram®, and the like) have been growing in popularity over the last decade. With this growth in popularity, individuals are spending more time online interacting with other individuals and organizations via these social media platforms. This amount of time spent online perusing social media presents a marketing opportunity for businesses to market their goods and services via the social media platforms and to engage with more of their user base. It is important to be able to track successes and failures for various marketing and advertising endeavors. Existing tools fail to provide sufficient opportunities to quantify successes and failures of social media campaigns.

Thus, there is a need in the art for systems and methods for measuring successes and failures of social media marketing campaigns.

### SUMMARY

Described herein is a method for tracking a business impact of social media campaigns. The method includes identifying or receiving a link to be shared in social media content. The method further includes generating a unique identifier to be associated with the social media content. The method further includes creating a trackable link by adding information corresponding to the unique identifier to the link. The method further includes inserting the trackable link into the social media content. The method further includes sharing the social media content with the trackable link on a social media platform. The method further includes retrieving impact data corresponding to a business impact of the social media content, the stored impact data being associated with the unique identifier. The method further includes generating a return on investment report (ROI report) by aggregating the impact data into a predetermined format. The method further includes outputting the ROI report.

In any of the foregoing embodiments, the impact data includes at least one of content insights associated with the social media content, content details associated with the social media content, or analytics data associated with the trackable link.

In any of the foregoing embodiments, the content insights, the content details, and the analytics data are each associated with the unique identifier, and the impact data includes each of the content insights, the content details, and the analytics data.

In any of the foregoing embodiments, the content insights are retrieved from a content insights database, the content details are retrieved from a content details database, and the analytics data is retrieved from an analytics engine.

Any of the foregoing embodiments may further include: receiving, by the content insights database, the content insights associated with the social media content from a reports server; and storing, by the content insights database, the content insights along with the associated unique identifier.

Any of the foregoing embodiments may further include storing, in a content details database, content details associated with the social media content along with the unique identifier.

In any of the foregoing embodiments, generating the unique identifier includes: selecting a predetermined quantity of random characters in a specific order to create a temporary identifier; determining that the temporary identifier is available if the selected characters in the specific order have not been previously used as a unique identifier; and setting the temporary identifier as the unique identifier when the identifier is available.

Any of the foregoing embodiments may further include: submitting a request for a ROI report for specific social media content; identifying all unique identifiers that are associated with the specific social media content; retrieving the impact data associated with each of the unique identifiers that are associated with the specific social media content; and generating the ROI report to include the impact data associated with each of the unique identifiers that are associated with the specific social media content.

In any of the foregoing embodiments, creating the trackable link includes: adding the unique identifier to the link; and shortening the link and using the shortened link as the trackable link that is inserted in the social media content.

Any of the foregoing embodiments may further include: receiving a request to compare success of multiple pieces of social media content; identifying unique identifiers associated with each of the multiple pieces of the social media content; generating a new ROI report by aggregating the impact data associated with each of the unique identifiers; and outputting the new ROI report.

Also disclosed is a system for tracking a business impact of social media campaigns. The system includes a return on investment (ROI) database configured to store a plurality of unique identifiers each associated with a respective piece of social media content of a plurality of pieces of social media content, and to store information associating each unique identifier with the respective piece of social media content, each of the plurality of pieces of social media content having a unique link therein that is associated with a respective unique identifier. The system further includes an impact data database configured to store impact data for each of the plurality of pieces of social media content. The system further includes a ROI server in electronic communication with the ROI database and the impact data database and configured to: receive input corresponding to a request to view impact data corresponding to a business impact of a selected portion of the plurality of pieces of social media content, identify specific unique identifiers associated with the selected portion of the pieces of social media content using information stored in the ROI database, retrieve the impact data from the impact data database using the specific unique identifiers, the impact data being associated with the selected portion of the pieces of social media content, and generate a ROI report by aggregating the impact data into a predetermined format.

In any of the foregoing embodiments, the impact data database includes: a content details database configured to store content details for at least a portion of the plurality of pieces of social media content; and a content insights database configured to store content insights for at least a portion of the plurality of pieces of social media content.

Any of the foregoing embodiments may further include a reports server configured to communicate with multiple social media platforms to receive the content insights, and to communicate with the content insights database to cause the content insights database to store the content insights.

In any of the foregoing embodiments: the ROI server is further configured to transmit a request for analytics data to an analytics engine, the request being for the analytics data associated with each of the specific unique identifiers, and to receive the analytics data associated with each of the specific unique identifiers; and the impact data further includes the analytics data.

Any of the foregoing embodiments may further include a user device configured to: transmit the input corresponding to a request to view the impact data to the ROI server; receive the ROI report from the ROI server; and output the ROI report.

In any of the foregoing embodiments, the ROI server is further configured to: identify a new link to be shared in new social media content; generate a new unique identifier to be associated with the new social media content; create a trackable link by adding information corresponding to the new unique identifier to the new link; and insert the trackable link into the social media content for sharing.

In any of the foregoing embodiments, generating the new unique identifier includes: selecting a predetermined quantity of random characters in a specific order to create a temporary identifier; determining that the temporary identifier is available if the selected characters in the specific order have not been previously used as a unique identifier; and setting the temporary identifier as the new unique identifier when the identifier is available.

In any of the foregoing embodiments, the ROI server is further configured to: add the new unique identifier to the new link; shorten the new link; and use the shortened new link as the trackable link that is inserted into the social media content.

Also disclosed is a method for tracking a business impact of social media campaigns. The method includes storing a plurality of unique identifiers each associated with a respective piece of social media content of a plurality of pieces of social media content. The method further includes storing information associating each unique identifier with the respective piece of social media content, each of the plurality of pieces of social media content having a unique link therein that is associated with a respective unique identifier. The method further includes storing impact data corresponding to a business impact of each of the plurality of pieces of social media content, the impact data being associated with a respective unique identifier for each of the plurality of pieces of social media content. The method further includes receiving a request to view impact data for a selected portion of the plurality of pieces of social media content. The method further includes identifying specific unique identifiers associated with the selected portion of the pieces of social media content. The method further includes retrieving the impact data using the specific unique identifiers. The method further includes generating a ROI report by aggregating the impact data into a predetermined format.

Any of the foregoing embodiments may further include: identifying a new link to be shared in new social media content; generating a new unique identifier to be associated with the new social media content; creating a trackable link by adding information corresponding to the new unique identifier to the new link; and inserting the trackable link into the social media content for sharing.

### BRIEF DESCRIPTION OF THE DRAWINGS

Other systems, methods, features, and advantages of the present disclosure will be or will become apparent to one of ordinary skill in the art upon examination of the following figures and detailed description. It is intended that all such additional systems, methods, features, and advantages be included within this description, be within the scope of the present disclosure, and be protected by the accompanying claims. Component parts shown in the drawings are not necessarily to scale, and may be exaggerated to better illustrate the important features of the present disclosure. In the drawings, like reference numerals designate like parts throughout the different views, wherein:

FIGS. 1A and 1B show a block diagram illustrating a system for monitoring social media marketing efforts, in accordance with various embodiments of the present disclosure;

FIGS. 2A and 2B show a flowchart illustrating a method for automatically creating a link having a unique identifier for monitoring social media marketing efforts, in accordance with various embodiments of the present disclosure;

FIG. 3 is a communication diagram illustrating communications within a system for monitoring social media marketing efforts, in accordance with various embodiments of the present disclosure;

FIG. 4 is a flowchart illustrating a method for monitoring social media marketing efforts, in accordance with various embodiments of the present disclosure;

FIG. 5 is a block diagram illustrating exemplary benefits of using a system and a method for monitoring social media marketing efforts, in accordance with various embodiments of the present disclosure;

FIG. 6A is a drawing of a screenshot illustrating an exemplary output generated by a system or method for monitoring social media marketing efforts, in accordance with various embodiments of the present disclosure;

FIG. 6B is a drawing of a screenshot illustrating an exemplary output generated by a system or method for monitoring social media marketing efforts for ranking team members, in accordance with various embodiments of the present disclosure;

FIG. 6C is a drawing of a screenshot illustrating an exemplary output generated by a system or method for monitoring social media marketing efforts for ranking types of social media content, in accordance with various embodiments of the present disclosure;

FIG. 6D is a drawing of a screenshot illustrating an exemplary output generated by a system or method for monitoring social media marketing efforts for ranking specific content, in accordance with various embodiments of the present disclosure; and

FIG. 7 is a block diagram illustrating features of an exemplary computing device, in accordance with various embodiments of the present disclosure.

### DETAILED DESCRIPTION

Due to its widespread presence and mainstream use, social media has increasingly been used by businesses to connect with prospective and existing customers by creating awareness for their products or services. In an effort to engage with social media users, businesses spend a significant amount of time and money generating content to be shared in social posts, generating and replying to private messages, and generating and responding to public comments. Given the time spent on and the investments allocated to the creation of social media content and management of incoming communications on social media, expectations and criticisms may gradually emerge from business owners and business leaders who require a justification of the human and monetary resources dispensed for social media marketing.

There exists a limited selection of solutions accessible to social media marketing teams with the purpose of demonstrating the effectiveness of their marketing activities on social media. Traditionally, social media marketers have been able to track at least some business data using urchin tracking module (UTM) codes in conjunction with analytics tools such as traffic, conversions, and revenue. UTM codes may include text added to an internet-based hyperlink that allow analytics tools to track some aspects of web traffic based on clicks of the hyperlink. Nevertheless, UTM codes are limited in their ability to provide granular data points from which the actual source of website visitors, conversions, or revenue can be uncovered. For example, UTM codes are limited in their ability to measure which pieces of content have the most impact on revenue, which content creator is able to generate the most conversions, and which content format generates the most traffic.

Accordingly, UTM codes are very limited in their ability to provide clear answers as to which types of activities businesses should focus on (e.g., because they are producing the expected results) and which types of activities may be avoided (e.g., because they consistently fail to produce expected results). By limiting the type of data that is being tracked in the conventional fields UTM codes offer (i.e., source, medium, campaign, content), too many crucial data points cannot be captured (such as author, date and time, social profile, content format, content category, content topic, etc.). These data points can strongly affect how decisions are made by social media marketers and business leaders.

Moreover, social media marketing teams currently insert these UTM parameters manually into each of the hyperlinks that are posted on social networks. This sort of hands-on task is laborious and inefficient considering the great quantity of social media content which may be published daily. Additionally, the process of integrating third-party analytics tools may prove difficult for marketing teams, particularly in the context of inputting and extracting data from them and blending them with content details. Content details refers to details regarding content published or otherwise distributed on a social media platform and may include, for example, a type of content (image, video, text, etc.), the author of the content, the date and time at which the content has been published, a specific social profile where the content has been published, a label applied to the content, or the like.

Where used throughout this disclosure, social media content refers to any information published or shared on a social media platform. Social media content may include a public post, a comment to a post by another user, a direct message between two or more users, a group message, or any other content on social media. Where used throughout this disclosure, social media may refer to websites, web applications, or mobile applications where users may exchange messages or create content with text, photos, videos, audio, or the like, and other users may engage with that content through reactions, comments, private messages, reviews, or the like. A social media platform may refer to an application, website, hardware, software, or the like that operates to provide a social media network. In that regard, a plurality of servers may host a social media platform, and users may interact with the social media platform and other users via communications with the platform. Examples of social media platforms may include Facebook®, X (formerly Twitter®), LinkedIn®, Youtube®, Pinterest®, Instagram®, TikTok® and the like.

Although the application of UTM parameters to track social media marketing performance is not unfamiliar, the automation of UTM tracking and of complementing analytics data from third-party analytics tools with content details from local databases has not yet been explored for social media marketing despite automated tracking mechanisms for other areas of marketing (such as email marketing, paid advertising, or marketing automation software).

Given the desire to measure the business impact of all marketing activities, there exists a need in the art for techniques and operations that provide an automated component for creating and tracking marketing efforts on social media platforms (e.g., automatic link tracking using UTM, tracking parameters for links published on social media, etc.) and a combination of engagement data for such efforts provided by application programming interfaces (APIs) of social networks with business data provided by a business analytics platform.

The present disclosure describes systems and methods for tracking the business impact of social media content published on social media platforms (e.g., Facebook®, LinkedIn®, or Youtube®). More specifically, various embodiments of the present disclosure relate to electronic systems and methods for tagging and coding uniform resource locators (URLs) to social media content, and to determining the presence of, and monitoring, patterns regarding how social media content generates a measurable business impact. A measurable business impact indicates the tendency of social media content to generate website traffic, lead conversions, and drive revenue.

In order to track a measurable business impact, the systems and methods of the present disclosure may add a unique identifier within, or in addition to, conventional UTM codes of a URL. Although the present disclosure describes combining a unique identifier with a UTM code, those of ordinary skill in the art will realize that a unique identifier may be combined with non-UTM codes or identifiers without departing from the scope of the present disclosure. A unique identifier such as the one described above and below may be used to combine content details with business analytics data, allowing granular insights as to the activities generating business value on social media to surface.

In some embodiments, a URL including a unique identifier can be used by an analytics engine (e.g., an analytics engine 106) to group conversion types and revenues by author, social profile, social post types (e.g., whether the content includes an original post, a comment, a private message, a shared post, or the like), social post date and time, among other measurable factors. An analytics engine may refer to at least one of software or hardware designed to collect and analyze analytics data corresponding to content performance of social media content containing a URL. Analytics data may refer to data indicating performance of social media content containing a URL, and may include, for example, data regarding website visits, bounce rate, time on site, or any type of data regarding the behavior of a website visitor, any type of lead conversion such as online registration, account creation, content download, product added to cart, revenue, or the like. In that regard, tagging URLs with a unique identifier allows an analytics engine to track website traffic, lead conversions, and revenue (along with other measurable factors) generated across multiple social profiles, specific social media content, authors of social media content, dates and times of posted social media content, and the like. An analytics engine can determine which piece(s) of social media content generates website visits, achieve marketing goals completions, and drive revenue. For example, an analytics engine may determine whether social media content should be promoted through paid advertisement based on a previously obtained organic measurable business impact.

UTM codes are traditionally used to describe certain attributes of an individual website visitor and his or her subsequent actions. These attributes are constrained by the limited numbers of tracking parameters available (i.e., source, medium, campaign, term, content). However, various embodiments described herein additionally permit website visitors to “inherit” attributes (e.g., author, social post type, social profile, date and time, etc. of social media content) relating to a piece of social media content on which they clicked prior to their website visit which are stored in a local database of a social media management tool. In that regard, the systems and methods described herein allow for more detailed determination of a website visitor's attributes, thus allowing a marketing team to better identify social media activities that result in measurable benefit to a business. Such embodiments allow for a more accurate measurable business impact attribution being that a unique identifier can add an infinite number of attributes to any given UTM code so long as attributes are stored on a social media management database and linked to a unique identifier.

For example, when a piece of social media content is being published on several Facebook® pages, traditional UTM codes may, at most, attribute an overall measurable business impact to the Facebook® platform. A unique identifier as described herein will attribute an eventual measurable business impact to an individual Facebook page from which social media content originates. Following the same logic, if a piece of social media content is being published several times at different dates and times on the same social network, traditional UTM codes may, at best, attribute an overall measurable business impact to a social network and to a content medium. A unique identifier as described herein will attribute an eventual measurable business impact to the exact date and time at which it was originated.

Because no connections exist between a social media management tool and an analytics engine, the introduction of a unique identifier represents an optimal method for creating a connection between content details and analytics data and for enriching both datasets. Because a social media management tool stores all the data relating to the context in which social media content was posted and an analytics tool stores all the data relating to what follows the publication of social media content, but no connections exist between the two, the unique identifier is the only way to create that connection and enrich the data both ways.

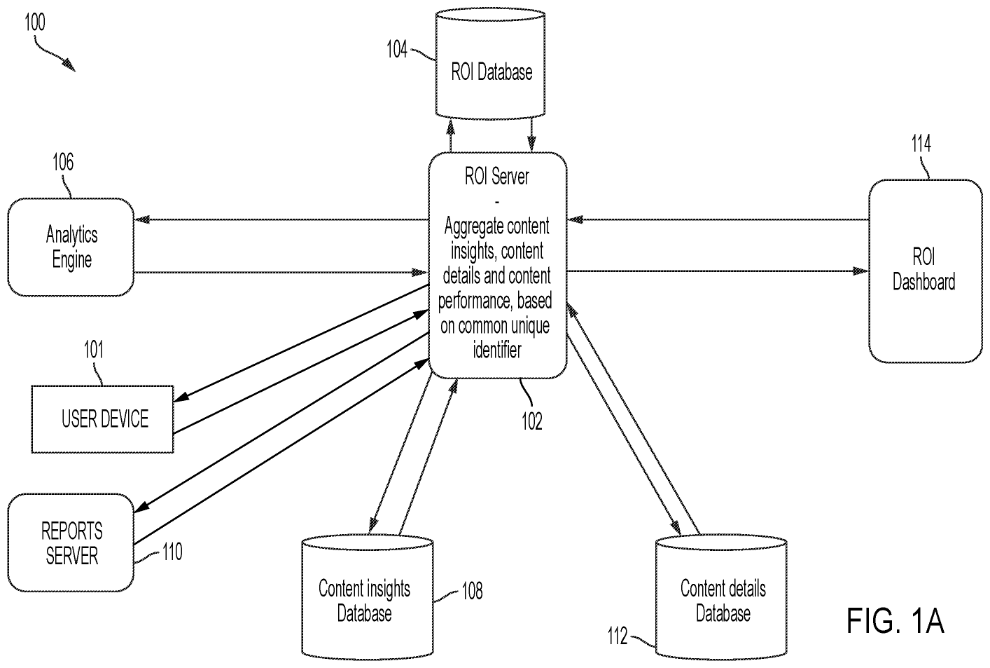

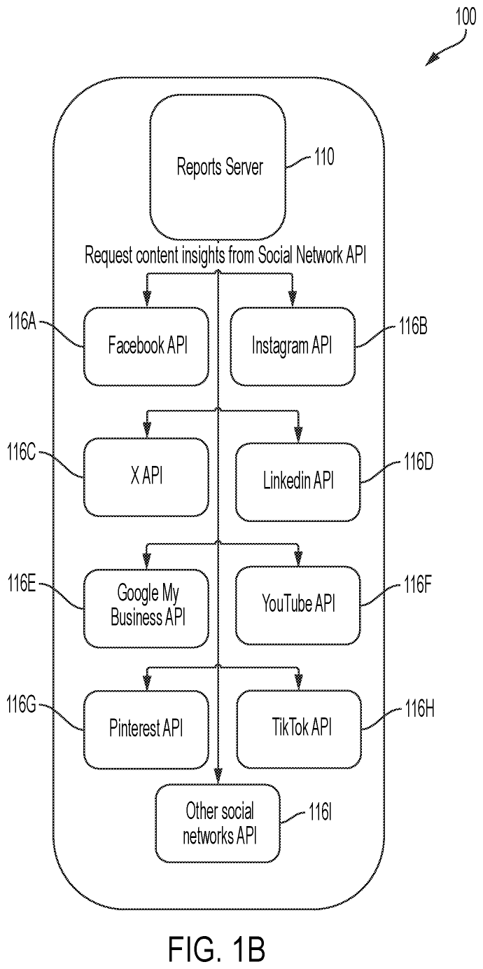

Referring now to FIGS. 1A and 1B, exemplary operation of a system 100 of the present disclosure is shown. The system 100 may include a return-on-investment (ROI) server 102 and a ROI database 104 which may be in communication with social networks (including servers hosting social media platforms), third-party analytics tools available from an analytics engine 106, and additional servers and databases such as a content insights database 108, a content details database 112, and a ROI dashboard 114. Likewise, a user device 101 may interact with the various elements of the system 100 (e.g., the user device 101 may transmit and receive data from the ROI server 102, and the ROI server 102 may communicate with any other elements of the system 100). In some embodiments, the ROI dashboard 114 may be output on the user device 101, and may thus be part of, or coupled to, the user device 101. In some embodiments, a ROI dashboard server may generate the ROI dashboard 114. In some embodiments, the ROI dashboard 114 may be displayed on any one or more of the user device 101, the ROI server 102, a ROI dashboard server, a remote device with credentials to access the dashboard, or the like. The user device 101 may include, for example, a mobile telephone (e.g., a smartphone), a laptop computer, a desktop computer, a tablet, or any other computing device.

In some embodiments, any functions performed by any element of the system 100 may be performed by a different element than that shown, multiple functions may be performed by a single element (e.g., the functions of the content insights database 108 and the content details database 112 may be performed by a single server), or the like. In some embodiments, a single server may perform all functionality shown in FIGS. 1A and 1B. Likewise, any element of the system 100 may include one, two, or more physical elements that together perform one or more of the functions of the element (e.g., the ROI server 102 may include a distributed computing system which includes 3 servers that, operating together, perform the functions of the ROI server 102). Any one or more element of the system 100 may be cloud-based. In that regard, other element(s) of the system may access the cloud-based element via the internet or another computing network. Any one or more element of the system 100 may be operated by a single entity or by multiple entities. For example, the ROI server 102, the ROI database 104, the content insights database 108, the reports server 110, and the content details database 112 (and the ROI dashboard 114) may be operated by a single operator, while the user device 101 is operated by a user that is separate from the single operator, and the analytics server 106 is operated by another entity that is separate from the single operator.

A unique identifier may be assigned to a specific hyperlink (which includes a URL) that is associated with social media content that is published by a user of the system 100 (e.g., posted by the user device 101). The unique identifier may be used to track data regarding interaction with the hyperlink in the post, as described below, and may be included in the URL of the hyperlink within the post. In that regard, a user of the system 100 may generate social media content which includes a link that directs a user who clicks on the link to a web page that includes a product or service offered by the user of the system. The link may include the unique identifier that is assigned by the system 100. Data relating to any interaction with the link (as well as actions occurring post-click, such as downloads, registrations or purchases) may be tracked and stored by the system 100 and later accessed by the user in order to learn which marketing techniques work and to optimize marketing efforts.

In an exemplary operation, the ROI server 102 may receive a request from a user (e.g., via the user device 101) for information and statistics related to social media content and engagement with a website linked to within the social media content. For example, the social media content and website may be engaged by individuals routed to the website via the link within the social media content. The request may include an identifier of the link within the social media content, which may include the unique identifier assigned to the link or any other identifier. The ROI server 102 may then transmit a request to the ROI database 104 for the unique identifier(s) (e.g., UTM content parameter (UTM_content) codes) that is associated with the link within the social media content. The ROI database 104 may in turn return (or the server 102 may retrieve) the unique identifier(s) to the ROI server 102. In some embodiments, the user (and ROI server 102) may request a list of all links posted or generated by an account associated with the user (or a list of unique identifiers associated with links posted by the account). That is, if the user wishes to review engagement with multiple links posted by different marketing professionals, then the user may request this information for each of these separate links. This advantageously allows the user to compare engagement with different pieces of social media content to quantify the success of various marketing professionals and various types of social media content.

After receiving the list of unique identifiers, the ROI server may transmit a request to the analytics engine 106 for analytics data from analytics software (such as, for example, Google Analytics) on a specific identifier code (e.g., a specific utm_content unique identifier). That is, the analytics engine 106 may include specific software running on a server that at least one of stores or generates analytical data associated with interactions with a specific hyperlink (e.g., the link with the unique identifier). The analytics engine 106 may be operated as part of the system 100 or may be operated and managed by a third party. The analytics engine 106 may in turn return (or the server 102 may retrieve) analytics data for the specific unique identifier. The analytics data may refer to statistics or data related to interaction with a link (that is associated with a unique identifier) by parties on the social media platform on which the link was shared. That is, the analytics data corresponds to engagement with a website that the link is associated with by users who found the link in the social media content. For example, the analytics data may include information corresponding to a quantity of visitors of the link (e.g., quantity of individual accounts that clicked on the link in the social media content), actions performed by the visitors (e.g., whether users viewed multiple products or services, whether users signed up to receive more information, whether users made one or more purchase, or the like), revenues generated by the visitors, a goal value (i.e., a target value corresponding to desired results such as whether individuals signed up for a service), goal completion (i.e., whether the social media content achieved the target value), or the like. The analytics data may be separated by each unique identifier (e.g., each utm_content unique identifier) that is transmitted by the ROI server 102. In some embodiments, the analytics data may be collected and/or generated by the ROI server 102 or by any other server. In some embodiments, the analytics engine 106 may be a cloud-based system. In that regard, the functions of the analytics engine 106 may be performed by a cloud-based server or group of servers, a dedicated analytics server, other hardware of the system 100 (e.g., the ROI server 102), or the like.

A reports server 110 may, periodically, from time to time, or upon request, query various social media platforms 116 (e.g., Facebook® 116A, Instagram® 116B, LinkedIn 116D, etc.) for detailed statistics regarding at least one of: (a) content within one or more item of social media content (or one or more link associated with social media content; each post or link being associated with one or more unique identifier); or (b) engagement with the social media content. In some embodiments, the reports server 110 may receive this information without querying (e.g., the social media platforms may periodically or from time to time transmit this information to the reports server 110). In some embodiments, the reports server 110 may automatically query the social media platforms 116 for these detailed statistics at set periods (e.g., once daily). In some embodiments, a user of the system 100 may manually force a query via interaction with the reports server 110 (e.g., by interacting with a user interface of the ROI server).

These detailed statistics may be referred to as content insights as they relate to content within one or more social media platform. That is, content insights may refer to engagement with the specific social media content which includes the specific link associated with the unique identifier by individuals who found the social media content on a social media platform. The content insights may include, for example, how many individual users saw the social media content, a percentage of users who watched an entire video included in the social media content, a quantity of individuals who “liked” the social media content (i.e., by clicking a “like” button), a quantity of comments posted on the social media content, or the like.

The reports server 110 may query the social networks 116 once daily, twice daily, or the like for each unique identifier. The reports server 110 may, for example, communicate with the social networks 116 via an application programming interface (API). The reports server 110 may be operated as part of the system 100, may be operated by a third party, or any combination thereof. These content insights may be provided to a content insights database 108 periodically, from time to time, or upon request, and may be stored in the content insights database 108. The content insights database 108 may query the reports server 110 for the content insights, the reports server 110 may transmit the content insights to the content insights database 108 without being prompted, or any combination thereof. The detailed content insights stored in the content insights database 108 may include, for example, reach of social media content, engagement with social media content, impressions of the social media content by visitors, a quantity of clicks on the post or links within the post, a quantity of likes or other reactions to the social media content, a quantity of comments associated with the social media content, a quantity of times that the social media content was shared, any additional statistics that are or may be provided by social network platforms through their APIs, etc.

The ROI server may transmit a request to the content insights database 108 for content insights for a given element of social media content or posts that is associated with one or more unique identifier. The content insights database 108 may then return the content insights corresponding to the social media content to the ROI server 102 (or the ROI server 102 may retrieve the content insights) that are associated with the one or more unique identifier. The content insights may already be stored on the content insights database from previous updates of the content insights by the reports server 110.

After each element of social media content generated by a user of the system 100 is published on a social network (e.g., via a publishing server, not shown), content details regarding the content of the post are stored in the content details database 112. Content details may refer to details regarding the specific social media content in which the link is included. The content details may include, for example, the social media platform on which the content was posted, the type of content included in the social media content (image, video, text only, etc.), its author, a label corresponding to the content, any unique identifier that has been associated with the content, a date and time of publication, a profile that the content has been posted to, the tone of the content, any information that characterizes the content the social media content is made of, or the like.

The ROI server may then transmit a request to the content details database 112 requesting content details for a specific link or post (e.g., by transmitting a unique identifier to the content details database 112). Because the content details database 112 stores content details for each piece of social media content that is published or shared by a user of the system, the content details database 112 may return the content details associated with the one or more unique identifier to the ROI server 102.

The data received from the analytics engine 106, the content insights database 108, and the content details database 112 related to a piece of social media content may be associated with a unique identifier that was generated by the ROI server 102. The data received from each of the analytics engine 106, the content insights database 108, and the content details database 112 may be referred to as “impact data” as it may provide information relating to an impact of the social media content. That is, the content details, the content insights, and the analytics data together may be referred to as impact data. In that regard, a user may request all impact data that is associated with a link shared in the piece of social media content by retrieving the impact data that is associated with the unique identifier.

In some embodiments, one or more of the content details, the content insights, and the analytics data may be referred to as impact data as this information may correspond to a business impact of the social media content. That is, the impact data may be associated with the unique identifier for each of the links used in the social media content, and may used to identify the business impact of the social media content. In that regard, one or both of the content insights database 108 and the content details database 112 may be referred to as an impact data database. In some embodiments, the analytics engine 106 may also or instead be referred to as an impact data database.

After receiving the impact data from the ROI database 104, the analytics engine 106, the content insights database 108, and the content details database 112, the ROI server 102 may aggregate the received impact data for each specific unique identifier. The aggregated impact data may include the analytics data from the analytics engine 106, the content insights from the content insights database 108 (which is retrieved from social media APIs via the reports server 110), and the content details from the content details database 112. In some embodiments, the ROI server 102 may format the aggregated impact data and output the information as a ROI report. The ROI report may be output by an output device of the user device 101, an output device of the ROI server 1-2, an output device of a remote device connected to the ROI server 102 via a network, or any other output device. In some embodiments, the ROI server may have a set format into which the information is aggregated, may select an optimal format based on the specific information (e.g., to highlight areas which may be improved and other areas which work well), or may provide the information in a custom format requested by the user. In some embodiments, the information may be provided in numerical format, graphical format, chart format, any other format, or any combination thereof. In some embodiments, the ROI server 102 may select a format for each piece of information (or collection of related information) in a manner that best conveys the information. For example, the ROI server 102 may provide the analytics data in numerical format, the content insights in graphical format, and the content details in written format. In that regard, the data that is provided in the ROI report may be provided in a predetermined format that may be specified or provided by at least one of programming of the ROI server 102 (e.g., a preset formatting option), input received from a user, the specific values of the ROI report, or the like. The information may be retrieved from each element using the unique identifier that was assigned by the system 100 and, in some embodiments, the unique identifier may be included with the information that is aggregated.

In some embodiments, the ROI server 102 may include a dashboard engine and, in some embodiments, a separate dashboard server (which includes a dashboard engine) may be provided and may generate the ROI dashboard 114. The dashboard engine may generate a dashboard that includes the aggregated information (i.e., the aggregated impact data) that is oriented as discussed above. The dashboard may function as a user interface to allow the user to request certain information, and to output requested information in a predetermined format. That is, the dashboard engine may generate the ROI report in response to user interfacing with the dashboard.

The dashboard engine may be used to aggregate the information (i.e., impact data) to be output in the ROI report. The dashboard engine may also be used to format the ROI report using a desired formatting scheme. The dashboard engine may also be designed to highlight certain elements of the aggregated information based on an analysis of the information. In some embodiments, the dashboard engine may perform a portion or all of the aggregation steps (including selection of an optimal output format and formatting the information for the selected format). In some embodiments, the dashboard engine may generate a representation of the information using a standardized format (i.e., some or all of the analytics data, the content insights, the content details, and the unique identifier). For example, the standardized format may include a JSON representation; JSON is an open standard file format and data interchange format that uses human-readable text to store and transmit data objects consisting of attribute-value pairs and arrays, and is a common data format with diverse uses in electronic data interchange including that of web applications with servers. In some embodiments, the JSON representation may be provided to the user device 101 to be output via an output device of the user device 101. In some embodiments, the generated ROI report may be output or transmitted in a format that is different than a JSON representation.

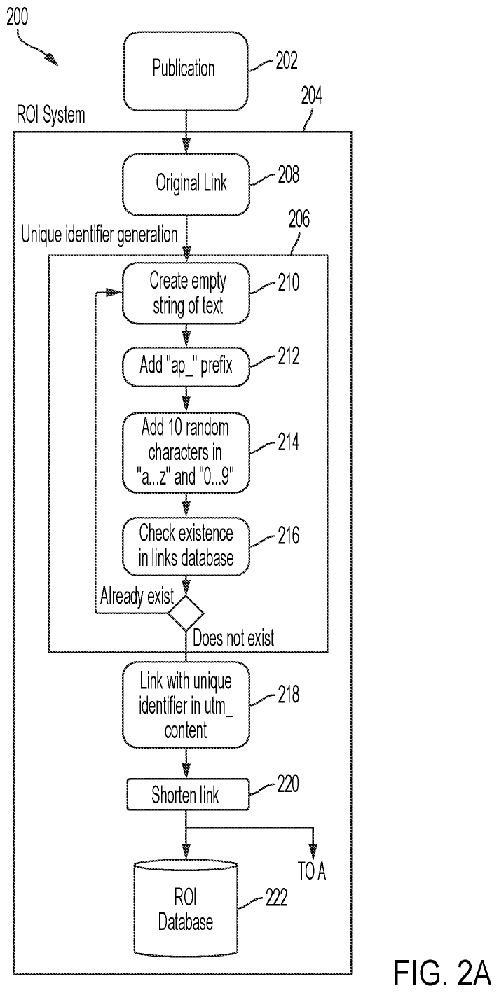

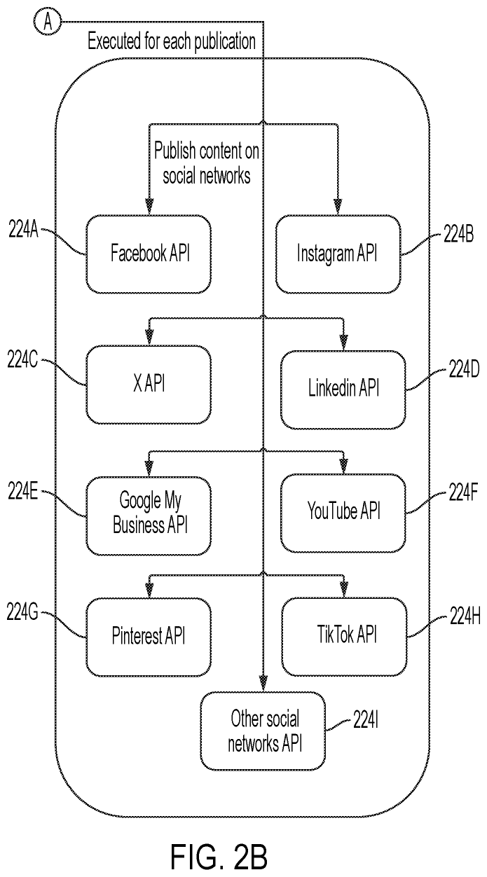

As referenced above, the system 100 may perform various functions, one of which includes generating a unique identifier that is associated with each link within social media content. FIGS. 2A and 2B illustrate a method 200 for generating a unique identifier that may be used to track hyperlinks that are published within a post on one or more social media platform. That is, the system 100 may perform a method similar to the method 200 of FIGS. 2A and 2B in order to generate a unique identifier. The method 200 may be performed using a system similar to the system 100 of FIGS. 1A and 1B. For example, a ROI system 204 may perform some or all blocks of the method 200. The ROI system 204 may include the ROI server 102 and the ROI database 104. In some embodiments, the ROI system 204 may include any of the elements from FIGS. 1A and 1B. In some embodiments, the method 200 may be performed each time a user generates, posts, or shares social media content with a link embedded or typed therein. In some embodiments, the method 200 may be performed automatically in response to user generation, posting, or sharing of social media content with a link therein.

The method 200 may include, in block 202, generation of social media content (which may include a hyperlink). For example, a user (or a computing system, e.g., using artificial intelligence (AI)) may create social media content for sharing on one or more social media platform. The social media content may include a hyperlink embedded or otherwise included therein. The social media content may then be published on the social network. Initially, the link within the social media content may be unadulterated (i.e., may be unaltered).

In block 208, the original link may be provided to a unique identifier generation engine 206 for generation of a unique identifier associated with the link. The unique identifier engine 206 may be included, for example, in a ROI server. In some embodiments, the unique identifier engine 206 may automatically generate a unique identifier for each piece of social media content (with a link therein) that is posted by a user. In some embodiments, the unique identifier may be added to the hyperlink to facilitate tracking of details and statistics related to social media content that includes the hyperlink.

The method 200 may include, in block 210, creating an empty string of text. The empty string of text may be of a set length (e.g., 10 characters, 15 characters, or any other quantity of characters), may be of variable length, or the like. In block 212, a prefix may be prepended to the empty string of text. The prefix may have any length and may include any one or more characters. In some embodiments, the characters of the prefix remain constant for each instance of the method (e.g., the prefix for each string may include “ap_”) and, in some embodiments, the characters may vary.

In block 214, a random set of characters may be added to the empty string of text. For example, each empty slot in the text string may be assigned a random character. In some embodiments, the string of text may be of a set length (e.g., 10 characters, 6 characters, or the like) and, in some embodiments, the string of text may be of a variable length. In some embodiments, the random characters may each include a character from a set grouping of characters. For example, each character may include at least one of a letter (e.g., “a, . . . , z”) or a number (e.g., “0, . . . , 9”). In some embodiments, the set of characters may have a non-random pattern. For example, each iteration of the method 200 may generate a set of characters that increments in value by one (e.g., the first iteration may output “00000A1,” the second iteration may output “00000A2,” and the third iteration may output “00000A3).

In block 216, the method may include determining whether the character string already exists in a database (e.g., in the ROI database of FIG. 1A). If the character string already exists then the method may return to block 210 to generate a new character string. If the character string is new and has not been previously generated, then the method 200 may proceed to block 218.

The method may, in block 218, generate a new link that includes the unique identifier therein. The new link may be referred to as a trackable link as it may include information corresponding to the unique identifier. For example, the new, trackable link may include the unique identifier appended at the end of the original link. For example, an original link “www.sample-sales-interface.com,” may be revised to “www.sample-sales-interface.com/00000A1.” In some embodiments, the unique identifier may be added to a utm_content field of the original link. For example, the link “www.sample-sales-interface.com,” may be revised to “www.sample-sales-interface.com?utm content-00000A1.” In some embodiments, the trackable link may include a reference to the unique identifier without actually including the unique identifier. For example, the trackable link may include a pointer to a location in the database in which the unique identifier is stored, such that the pointer is the information corresponding to the unique identifier.

In block 220, the new link may be shortened such that the shortened link is now a trackable link. This may be performed to increase ease of sharing of the link, and such that the link requires less space in social media content. The link may be shortened by either an external provider (e.g Bitly®), directly by creating a new hyperlink with the unique identifier generated in block 214, or directly by creating a new hyperlink with other information corresponding to the unique identifier (e.g., a pointer or other reference to the unique identifier). For example, the link “www.sample-sales-interface.com?utm content=00000A1” may be shortened to “bit.ly/A1.” As another example, the link “www.sample-sales-interface.com?utm content=00000A1” may be shortened to “www.short.com/pointer1.” The shortened link may include the full unique identifier, a shortened version of the unique identifier, or no portion of the unique identifier. In some embodiments, the new link may not be shortened and may be shared as-is with the unique identifier included.

After the new link and the shortened link have been generated, the link(s) may be stored in a database (e.g., a ROI database) in block 222. For example, at least one of the original link, the new (non-shortened) link, the shortened link, or the unique identifier may be stored in the database. In some embodiments, the social media content (or an identifier of the social media content) may also be stored in the database and associated with at least one of the link(s) or the unique identifier. The database may be capable of matching the unique identifier of each link with at least one of the original link, the new non-shortened link, or the new shortened link.

In blocks 224A through 224I, the social media content with the new and/or shortened link may be shared on one or more social media platform. In some embodiments, the post may be published on the social media platform(s) prior to a portion or all of the method 200 occurring. In that regard, the method 200 may, in blocks 224A-224I, update the link in the previously published posts to include at least one of the new link (i.e., with the unique identifier) or the shortened link (i.e., which is associated with at least one of the new link or the unique identifier. In that regard, the new link or the shortened link may be used to provide detailed statistics regarding marketing results obtained using the social media content.

In some embodiments, an iteration of the method 200 may be performed for each piece of social media content in which a link is shared. For example, if a user shares a link to (1) a Facebook® page and (2) an Instagram@ page, then the method may be performed once for the Facebook® post and once for the Instagram® post. In that regard, a first unique identifier will be associated with the link shared via Facebook®, and a second unique identifier will be associated with the link shared via Instagram®. In that regard, each unique identifier may be associated with a single post on a single social media platform.

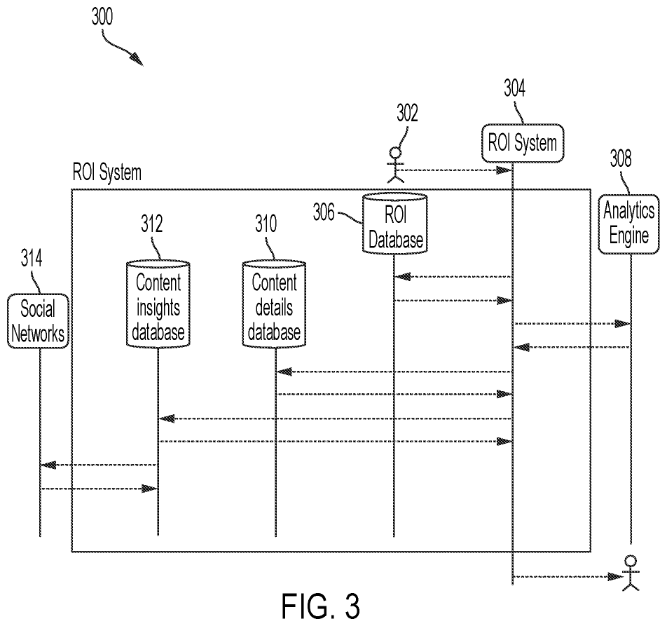

Referring now to FIG. 3, a communication diagram 300 illustrates operation of a system similar to the system 100 of FIGS. 1A and 1B to obtain detailed statistics relating to marketing effects of one or more piece of social media content. The system shown in the diagram 300 may include similar features as the system 100 of FIGS. 1A and 1B, and components in the diagram 300 may have similar capabilities and functions as the similar components in the system 100 (e.g., the analytics engine 308 may function in a similar manner as the analytics engine 106 of FIG. 1A). In particular, the system may include a user device 302, a ROI server 304, a ROI database 306, an analytics engine 308, a content details database 310, and a content insights database 312 which interfaces with one or more social media platform 314.

A user may, using the user device 302, request a report that provides the impact data regarding a hyperlink within social media content. The request may be made to a ROI server 304, and may include a defined period of time and one or more different parameters to request a subset of the data. The ROI server 304 may pull all unique identifiers from the account that were created during the defined period of time. The ROI server may then query the ROI database 306 to identify the social media content, the links, and the unique identifiers associated with the user's request, and this information may be returned to the ROI server 304. The ROI server may also query all links that include the unique identifiers associated with the user's request.

The ROI server 304 may then request statistics from the analytics engine 308. For example, the ROI server 304 may transmit the unique identifier (or other identifying information such as an identifier of a specific piece of social media content) to the analytics engine 308. The analytics engine 308 may then return statistics (e.g., analytics data) tracked by the analytics engine 308 such as number of clicks on the link, events and conversions that occurred after a click on the link, revenue generated after a click of the link, etc.

The ROI server 304 may then request content details from the content details database 310. For example, the ROI server 304 may transmit the unique identifier (or other identifying information such as an identifier of a specific piece of social media content) to the content details database 310. The content details database 310 may then return the content details to the ROI server 304. For example, the content details may include the text included within a post, images within the post, a type of post (e.g., public or friends only), a platform on which the post was posted, a type of media included in the post, an author of the post, a time of day that the post was published, etc.

The ROI server 304 may then request content insights from a content insights database 312. For example, the ROI server 304 may transmit the unique identifier (or other identifying information such as an identifier of specific social media content) to the content insights database 312. The content insights database 312 may then return the content insights to the ROI server 304. The content insights may include, for example, the reach of the social media content, engagement with the social media content, impressions of the social media content before users of the social media platforms, etc. The content insights database 312 may, periodically or from time to time, query one or more social media platform 314 to obtain the content insights. For example, the content insights database 312 may access the social media platforms 314 using APIs. The social media platforms 314 may provide the content insights to the content insights database 312, which may store them and provide them to the ROI server 304 upon request.

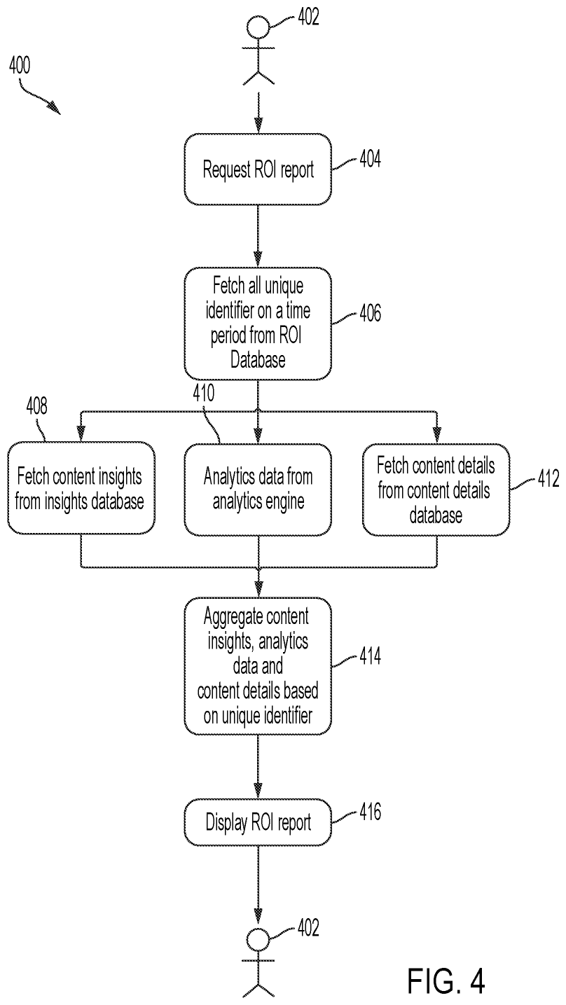

Turning now to FIG. 4, a method 400 for generating and displaying a ROI report (which may be generated in response to input received from a user via a dashboard) using a system similar to the system 100 of FIGS. 1A and 1B is shown. The method may begin in block 404 where a user 402 requests a ROI report for one or more hyperlink included within one or more piece of social media content. In block 404, the user may provide any identifier of the hyperlink or social media content such as the unique identifier. In some embodiments, the user may select a link or social media content using a graphical user interface (e.g., of the dashboard), for example, by clicking on a link or post. The user may also or instead select the link or post in any other known manner. The request in block 404 may be received by a ROI server (e.g., the ROI server 102 of FIG. 1A). The user may provide any type of information in the request. For example, the user may include a request for: all posts on a specific social media platform within a specified or predetermined time period, all social media posts by a specific employee in an organization, the top 10 percent of posts in terms of revenue generated, the bottom 15 percent of posts in terms of revenue generated, or the like. The ROI server (e.g., the ROI server 102 of FIG. 1A) may identify the specific posts based on the information included in the user request.

In block 406, the ROI server may determine or identify one or more link(s) or social media content based on the user request, and may also or instead determine or retrieve one or more unique identifiers associated with links or social media content for which the ROI report was requested in block 404. In some embodiments, the user request may include an identified period of time (e.g., a date range, a time of day range, a selected quantity of days, or any other identifiable period of time) for which the user wishes to view the report information (i.e., the impact data). In that regard, the ROI server may generate the ROI report that includes the impact data associated only with the requested time period. As mentioned above, the request in block 404 may include one or more unique identifiers. However, if the request includes different identifying information for the link(s) and/or social media content then the ROI server may receive the unique identifier(s) from a ROI database (e.g., the ROI database 104 of FIG. 1A). For example, the ROI server may transmit separate identifiers of the link(s) and/or social media content to the ROI database, and the ROI database may return the unique identifier(s). In that regard, the ROI server may obtain one or more unique identifier(s) in block 406.

After block 406, blocks 408, 410, and 412 may be performed sequentially, simultaneously, or any combination thereof, and may be performed in any order. In block 408, the ROI server may fetch (or otherwise receive) content insights associated with the one or more unique identifier from a content insights database (e.g., the content insights database 108 of FIG. 1A). In block 410, the ROI server may fetch (or otherwise receive) analytics data associated with the one or more unique identifier from an analytics engine (e.g., the analytics engine 106 of FIG. 1A). In block 412, the ROI server may fetch (or otherwise receive) content details associated with the one or more unique identifier from a content details database (e.g., the content details database 112 of FIG. 1A). In some embodiments, the ROI server may already have some or all of this information. For example, this information may have been previously received from one or more of the content insights database, the analytics engine, or the content details database, and may have been stored in the ROI database (e.g., the ROA database 104 of FIG. 1A). In that regard, the ROI server may compile the requested data from the ROI database. In some embodiments, if all information is not included in the ROI database, the ROI server may request supplemental information from one or more of the content insights database, the analytics engine, or the content details database to fully respond to each request.

In block 414, the ROI server may aggregate all of the information (i.e., the impact data) that was fetched or otherwise obtained in blocks 408, 410, and 412. That is, the ROI server may aggregate the content insights, the analytics data, and the content details that are associated with the one or more unique identifier. In some embodiments and as referenced above, the ROI server may format the received information into a visually appealing or easy-to-interpret format. In some embodiments, a separate server having a dashboard engine may aggregate and/or format the received information as desired or as programmed. In some embodiments, a predetermined graphical layout may be used to format the data being output in the ROI report. In some embodiments, a user may request a specific graphical layout or other format in which he desires the ROI report to be output.

In block 416, the ROI server may transmit the ROI report (i.e., the aggregated data) to a user device associated with a user 402, where the user device may output the ROI report. For example, the ROI report may be printed using a printer, displayed or otherwise output on an output device of the user device (e.g., a monitor, display, touchscreen, speaker, or the like) such that the user 402 may review and interpret the information within the ROI report. In some embodiments, an output device coupled to, or included with, the ROI server may output the ROI report in addition to, or instead of, a user device outputting the ROI report. In that regard, the ROI server may also function as a user device.

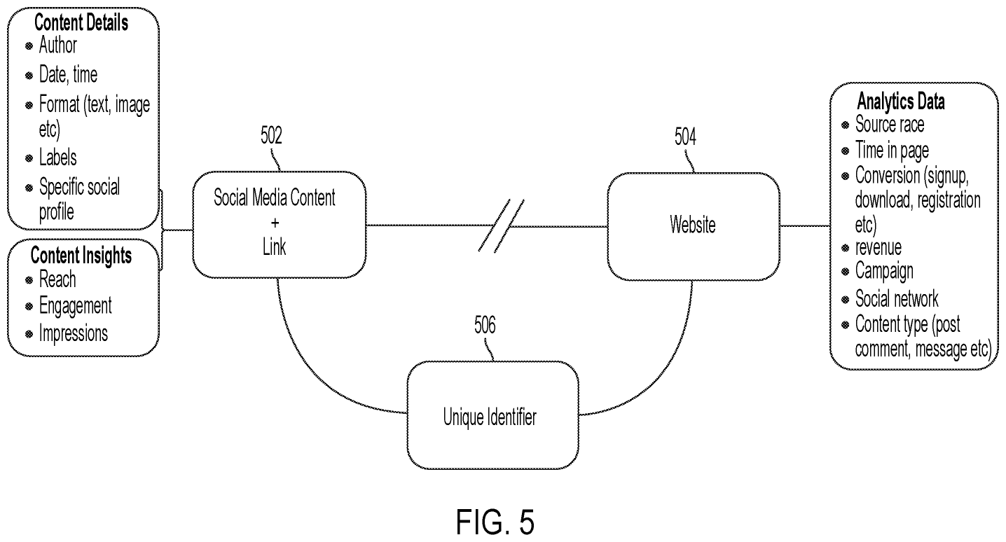

FIG. 5 is a drawing illustrating the benefits of using the systems and methods described in the present disclosure. A company may create a landing page 504 (i.e., a webpage) on which one or more products or services may be sold. The company may generate social media content 502 to be shared on social media. The social media content may include a link directing users to the landing page (e.g., the company may respond to a comment on a post published on its Facebook® page and include a link to the landing page 504 in the response). Content insights may be determined and recorded in a contents insights database (e.g., the author of the social media content, the date and time the social media content was published, the format of the social media content, any labels associated with the social media content, and a specific user that posted the social media content). In conventional systems, the link within the social media content may include UTM codes for tracking some business impacts of the social media content. However, as described above, the information that may be tracked using UTM codes is relatively limited.

As various users engage with the landing page 504 via links within social media content 502, an analytics engine may track and store analytics data corresponding to engagement with the landing page 504. This analytics data may include, for example, a bounce rate, a time on page, conversions (signup, download, registration, etc.), revenue, or the like. In conventional systems and using UTM codes, the analytics engine can link the analytics data with a specific campaign, social media network (e.g., Facebook®, X, or the like), and content type (e.g., an original post, a public comment on an existing post, a private message, or the like). For example, the analytics engine can inform a user that a specific conversion originated on a Facebook® private message. However, this information is relatively limited as the user will be unable to identify which specific message the conversion originated from, which social profile the conversion originated from, who was the author of the social media content the conversion originated from, and additional granular information that UTM codes are unable to track. In that regard, conventional systems and methods fail to connect specific content insights and content details with specific analytics data, providing only a high-level overview of success of social media campaigns. It must also be noted that this high-level overview provided by UTM codes is only made possible by the tedious manual creation of UTM codes for each and every link included in a piece of social media content.

However, by using unique identifiers 506, the systems and methods of the present disclosure allow the system to connect the specific content insights from social media content 502 with specific analytics data tracking engagement with a landing page 504. By connecting the content insights and the content details with the analytics data, a company is now able to obtain more granular information regarding the success of a social media campaign. For example, the company can now determine which social media format (e.g., images) generates the most revenue, which social media profile originates the most conversions, dates and times during which it is most beneficial to create social media content, and the like. A company may, from time to time, review this granular information and amend their social media strategy based on learnings from the granular information.

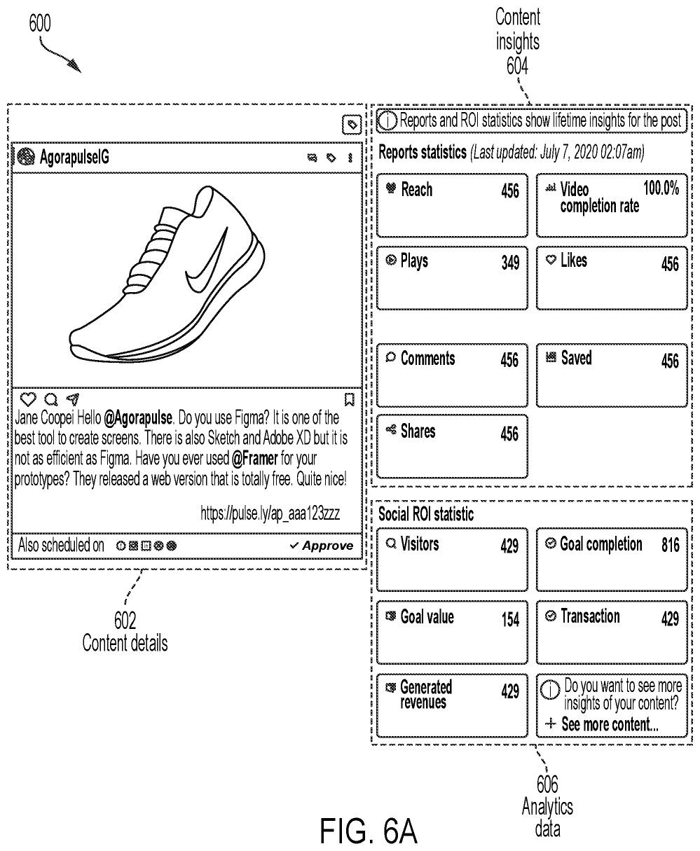

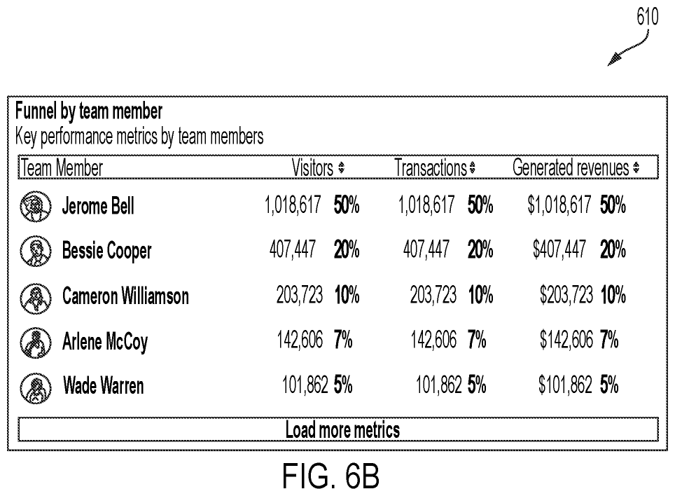

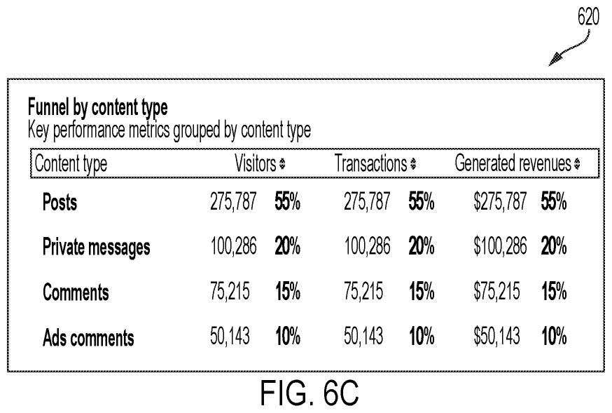

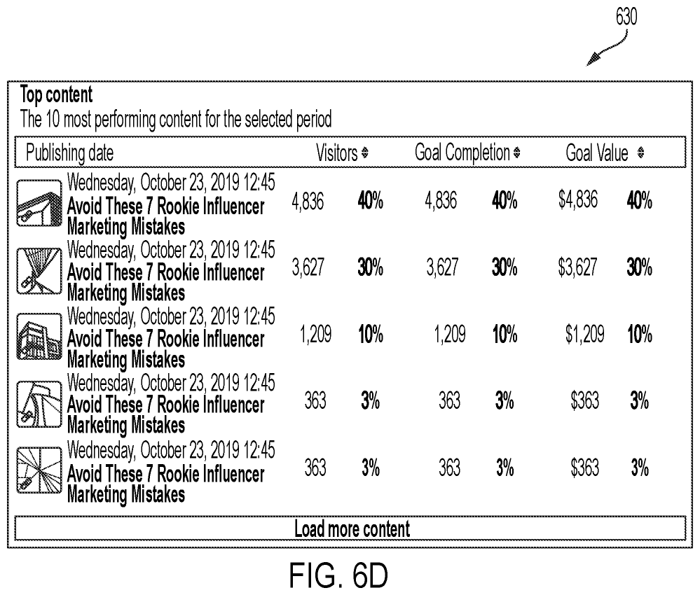

Turning now to FIGS. 6A through 6D, exemplary data that may be output on a ROI dashboard (e.g., the ROI dashboard 114 of FIG. 1A) is shown. For example, a user may request the output of certain data using a user device (similar to the user device 101 of FIG. 1A), and an output device of the user device may output the requested data. A ROI server (similar to the ROI server 102 of FIG. 1A) may collect or retrieve data to be used in the output, and may also compile the data to generate the requested output. In that regard, a user may totally customize the types of data that is compiled and output by the ROI dashboard based on what the user is hoping to learn from the data. In addition, the user may customize the format of the data that is output by the ROI dashboard for any reason, such as to make viewing easier, to prepare charts for meetings, or the like.

Referring specifically to FIG. 6A, an output 600 illustrates an exemplary ROI report shown on a dashboard. The ROI report may include summary data for a specific piece of social media content including some or all impact data (e.g., at least one of content details, content insights, or analytics data). Although specific data is shown in the output 600, the type of information that is provided is not limited to the types of information that is shown in FIG. 6A, and the format of information is not limited to the format that is shown in FIG. 6A. The data that is provided in FIG. 6A may be associated with a single piece of social media content that was published using a link that includes a specific unique identifier used to track the post and collect the information. In some embodiments, a user may control the system to cause the output 600 to output additional information or to only output a limited amount of this information based on the value of each type of data to the user.

In particular, a first portion of the dashboard may display data related to content details 602. As shown, the content details 602 include the specific information regarding the social media content. In the example shown in FIG. 6A, the content includes a post on Instagram® that includes an image and text associated therewith. In some embodiments, the content details 602 may include a reproduction of a social media post (or a reproduction of the social media content) in the format in which the content was originally posted.

A second portion of the dashboard may display data related to content insights 604. The content insights may provide information associated with the content that has been collected over a lifetime of the content. For example, the content insights 604 may include reach information corresponding to a quantity of unique accounts that has viewed the content at least once, and video completion rate corresponding to a percentage of unique accounts that have viewed the entire video (for video content) from start to finish (rather than stopping the video part of the way through). The content insights 604 may also include plays information corresponding to a quantity of extra times that the video has been viewed. The content insights 604 may also include likes information corresponding to a quantity of likes that the social media content has received on the social media platform, and comments information corresponding to a quantity of comments that have been posted in response to the content. The content insights 604 may further include saved information corresponding to a quantity of accounts that have saved the specific content to their account or device, and shares information corresponding to a quantity of times that the content has been shared on the social media platform.

A third portion of the dashboard may display data related analytics data 606. The analytics data 606 may include a quantity of unique visitors that visited the website from the link that was included in the social media content. The analytics data 606 may also include goal completion data that corresponds to a quantity of triggered goal completion events; these goal completion events may be set and adjusted by a user (e.g., an exemplary goal may include a quantity of items purchased using the link). The analytics data 606 may further include goal value data that corresponds to a total value received as a result of the completed goals; for example, the user may set a specific value for each goal, and the goal value data may include a quantity of goal completions multiplied by the value of the completed goals as set by the user. The analytics data 606 may also include transaction data corresponding to a quantity of triggered e-commerce events (e.g., a quantity of e-commerce transactions resulting from the social media content). The analytics data 606 may also include generated revenue data that corresponds to a quantity of transactions multiplied by a value of each transaction.

Turning to FIG. 6B, another output 610 illustrates another exemplary ROI report that is shown by a dashboard. The ROI report in FIG. 6B may include specific performance metrics for multiple team members within an organization. In the example of FIG. 6B, the performance metrics include a quantity of visitors, transaction information, and a quantity of generated revenue that is associated with each team member. However, a user may add or remove any of the performance metrics to adjust the output 610 that is shown. The output 610 shown here allows a manager to compare the success of various team members for which he is responsible. In particular, this output 610 allows the manager to identify a quantity of visitors to the organization's website resulting from social media content generated by each employee, identify a quantity of e-commerce transactions resulting from social media content generated by each employee, and identify a quantity of revenue that is generated as a result of social media content generated by each employee. This type of information provides value to an organization by allowing a manager to review the success of each employee based on measured data.

Referring now to FIG. 6C, another output 620 illustrates another exemplary ROI report that is shown by a dashboard. This ROI report may include specific performance metrics for multiple types of social media content. The information provided in the example of FIG. 6C may be used by an organization to identify a type of social media content that generates the best results, allowing the organization to focus on the type(s) of content that are likely to provide the best results. As with the example of FIG. 6B, a user may add or remove any of the performance metrics to adjust the output 620 that is shown. In particular, the output 620 compares a quantity of visitors, a quantity of transactions, and a quantity of generated revenue for each type of social media content. The types of social media content used in this example include original posts by an account of the organization, private messages between an account of the organization and an external account, public comments to an existing social media post, and public comments to an existing advertisement.

Turning now to FIG. 6D, another output 630 illustrates another exemplary ROI report that is shown by a dashboard. The ROI report may include specific performance metrics for multiple existing pieces of social media content. The information provided in the example of FIG. 6D may be used by an organization to rank the performance of multiple pieces of social media content. The pieces of social media content may include the same or different content, content posted on one or more social media platform, the same or different types of content, or the like. In addition, the user may request to view all pieces of content, the top or bottom X quantity of pieces of content (e.g., the top 10 performing pieces of content, or the bottom 25 performing pieces of content), or the like in order to customize the output 630. As shown in the example of FIG. 6D, the output compares 5 separate pieces of social media content based on a quantity of visitors to a link resulting from each piece of content, goal completion data achieved by each piece of content, and goal value data achieved by each piece of content.

As shown in FIGS. 6A-6D, the data collected and output by the system (similar to the system 100 of FIG. 1A) may provide significant value to an organization. The value provided by the system allows a team to focus on social media content that provides proven results, allows a manager to reward top performers in his organization, and learn how to achieve success using social media and improving his team based on the learned information.

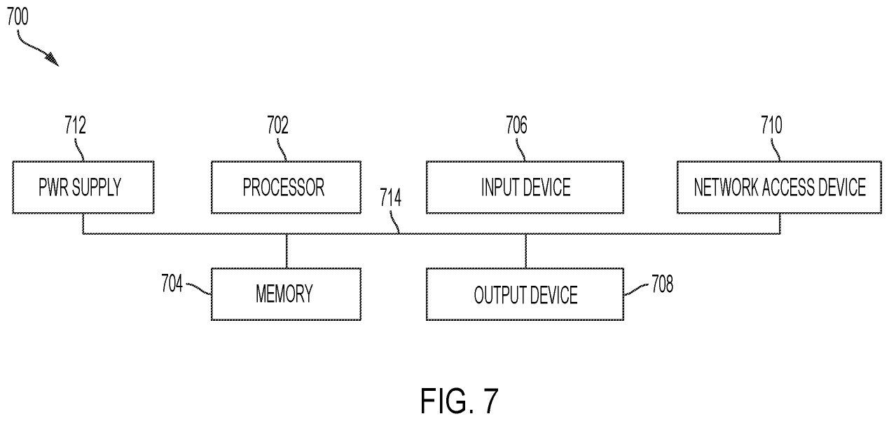

Referring now to FIG. 7, an exemplary computing device 700 is shown. Any one or more computing device described herein (e.g., the ROI server 102, the ROI database 104, the analytics engine 106, the content insights database 108, the reports server 110, the content details database 112, and the ROI server running a ROI dashboard 114 of FIGS. 1A and 1B) may include some or all of the features of the computing device 700.

The computing device 700 may include a controller or processor 702. The processor 702 may include any controller or processor capable of performing logic functions. For example, the processor 702 may include an application-specific integrated circuit (ASIC), a general-purpose processor, a field programmable gate array (FPGA), any combination of discrete logic devices that perform logic functions, or the like. In some embodiments, the processor 702 may further include a memory that stores instructions usable by the processor 702 to perform logic functions. The processor 702 may be housed within the electronic device 700, may include remote functionality (e.g., by providing cloud-based processing), or any combination thereof.

The computing device 700 may further include a memory 704. The memory 704 may include any non-transitory memory such as random-access memory (RAM), dynamic random-access memory (DRAM) read-only memory (ROM), or any other type of memory. The memory 704 may be housed within the electronic device 700, may include remote memory (e.g., cloud-based memory), may be external relative to the electronic device 700 (e.g., an external hard drive), or any combination thereof. The memory may store information usable by the processor 702 to perform logic functions, may store information as requested by the processor for later retrieval, or the like.

The computing device 700 may further include an input device 706. The input device 706 may include any one or more input device such as a mouse, a keyboard, a touchscreen, a microphone, or the like. The input device 706 may receive input from a user and convert the input into digital signals usable by the processor 702.

The computing device 700 may further include an output device 708. The output device 708 may include any one or more output device such as a display, a touchscreen, a printer, a speaker, or the like. The output device 708 may receive digital information from the processor 702 and may convert the digital information into a format that can be interpreted by a user.

The computing device 700 may also include a network access device 710. The network access device 710 may include one or more device capable of communicating with external elements via any wired or wireless protocol. For example, the network access device 710 may communicate via Ethernet, Bluetooth®, Wi-Fi, universal serial bus (USB), or the like. In that regard, the network access device 710 may communicate with the processor 702, may transmit information from the processor 702 to a remote device as requested by the processor 702, and may transmit information from a remote device to the processor 702. The network access device 710 may communicate with remote devices (e.g., may communicate with a remote server via the internet), may communicate with local devices (e.g., may communicate with a local printer), or the like.

The computing device 700 may further include a power supply 712. The power supply is designed to provide power to the computing device 700, providing electricity to the components of the computing device 700 to allow them to operate. The power supply 712 may include any power supply such as a cable and transformer designed to receive power from a wall socket, a battery, or any alternative or additional power supply.

The computing device 700 may also include connections or a bus 714. The connections or bus 714 may be connected to some or all components of the computing device 700 and may transmit at least one of a power signal or a data signal between components of the computing device. For example, power from the power supply 712 may be transmitted to the various components via the connections or bus 714, the processor may control the output device 708 by placing instructions on the connections or bus 714, or the like.

Where used throughout the specification and the claims, “at least one of A or B” includes “A” only, “B” only, or “A and B.” Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A method for tracking a business impact of social media campaigns, the method comprising:
identifying or receiving a link to be shared in social media content;
generating a unique identifier to be associated with the social media content;
creating a trackable link by adding information corresponding to the unique identifier to the link;
inserting the trackable link into the social media content;
sharing the social media content with the trackable link on a social media platform;
retrieving impact data corresponding to a business impact of the social media content, the stored impact data being associated with the unique identifier; and
generating a return on investment report (ROI report) by aggregating the impact data into a predetermined format; and
outputting the ROI report.

2. The method of claim 1, wherein the impact data includes at least one of content insights associated with the social media content, content details associated with the social media content, or analytics data associated with the trackable link.

3. The method of claim 2, wherein the content insights, the content details, and the analytics data are each associated with the unique identifier, and the impact data includes each of the content insights, the content details, and the analytics data.

4. The method of claim 2, wherein the content insights are retrieved from a content insights database, the content details are retrieved from a content details database, and the analytics data is retrieved from an analytics engine.

5. The method of claim 4, further comprising:
receiving, by the content insights database, the content insights associated with the social media content from a reports server; and
storing, by the content insights database, the content insights along with the associated unique identifier.

6. The method of claim 4, further comprising storing, in a content details database, content details associated with the social media content along with the unique identifier.

7. The method of claim 1, wherein generating the unique identifier includes:
selecting a predetermined quantity of random characters in a specific order to create a temporary identifier;
determining that the temporary identifier is available if the selected characters in the specific order have not been previously used as a unique identifier; and
setting the temporary identifier as the unique identifier when the identifier is available.

8. The method of claim 1, further comprising:
submitting a request for a ROI report for specific social media content;
identifying all unique identifiers that are associated with the specific social media content;
retrieving the impact data associated with each of the unique identifiers that are associated with the specific social media content; and
generating the ROI report to include the impact data associated with each of the unique identifiers that are associated with the specific social media content.

9. The method of claim 1, wherein creating the trackable link includes:
adding the unique identifier to the link; and
shortening the link and using the shortened link as the trackable link that is inserted in the social media content.

10. The method of claim 1, further comprising:
receiving a request to compare success of multiple pieces of social media content;
identifying unique identifiers associated with each of the multiple pieces of the social media content;
generating a new ROI report by aggregating the impact data associated with each of the unique identifiers; and
outputting the new ROI report.

11. A system for tracking a business impact of social media campaigns, the system comprising:
a return on investment (ROI) database configured to store a plurality of unique identifiers each associated with a respective piece of social media content of a plurality of pieces of social media content, and to store information associating each unique identifier with the respective piece of social media content, each of the plurality of pieces of social media content having a unique link therein that is associated with a respective unique identifier;
an impact data database configured to store impact data for each of the plurality of pieces of social media content; and
a ROI server in electronic communication with the ROI database and the impact data database and configured to:
receive input corresponding to a request to view impact data corresponding to a business impact of a selected portion of the plurality of pieces of social media content,
identify specific unique identifiers associated with the selected portion of the pieces of social media content using information stored in the ROI database,
retrieve the impact data from the impact data database using the specific unique identifiers, the impact data being associated with the selected portion of the pieces of social media content, and
generate a ROI report by aggregating the impact data into a predetermined format.

12. The system of claim 11, wherein the impact data database includes:
a content details database configured to store content details for at least a portion of the plurality of pieces of social media content; and
a content insights database configured to store content insights for at least a portion of the plurality of pieces of social media content.

13. The system of claim 12, further comprising a reports server configured to communicate with multiple social media platforms to receive the content insights, and to communicate with the content insights database to cause the content insights database to store the content insights.

14. The system of claim 11, wherein:
the ROI server is further configured to transmit a request for analytics data to an analytics engine, the request being for the analytics data associated with each of the specific unique identifiers, and to receive the analytics data associated with each of the specific unique identifiers; and
the impact data further includes the analytics data.

15. The system of claim 11, further comprising a user device configured to:
transmit the input corresponding to a request to view the impact data to the ROI server;
receive the ROI report from the ROI server; and
output the ROI report.

16. The system of claim 11, wherein the ROI server is further configured to:
identify a new link to be shared in new social media content;
generate a new unique identifier to be associated with the new social media content;
create a trackable link by adding information corresponding to the new unique identifier to the new link; and
insert the trackable link into the social media content for sharing.

17. The system of claim 16, wherein generating the new unique identifier includes:
selecting a predetermined quantity of random characters in a specific order to create a temporary identifier;
determining that the temporary identifier is available if the selected characters in the specific order have not been previously used as a unique identifier; and
setting the temporary identifier as the new unique identifier when the identifier is available.

18. The system of claim 16, wherein the ROI server is further configured to:
add the new unique identifier to the new link;
shorten the new link; and
use the shortened new link as the trackable link that is inserted into the social media content.

19. A method for tracking a business impact of social media campaigns, the method comprising:
storing a plurality of unique identifiers each associated with a respective piece of social media content of a plurality of pieces of social media content;
storing information associating each unique identifier with the respective piece of social media content, each of the plurality of pieces of social media content having a unique link therein that is associated with a respective unique identifier;
storing impact data corresponding to a business impact of each of the plurality of pieces of social media content, the impact data being associated with a respective unique identifier for each of the plurality of pieces of social media content;
receiving a request to view impact data for a selected portion of the plurality of pieces of social media content;
identifying specific unique identifiers associated with the selected portion of the pieces of social media content;
retrieving the impact data using the specific unique identifiers; and
generating a ROI report by aggregating the impact data into a predetermined format.

20. The method of claim 19, further comprising:
identifying a new link to be shared in new social media content;
generating a new unique identifier to be associated with the new social media content;
creating a trackable link by adding information corresponding to the new unique identifier to the new link; and
inserting the trackable link into the social media content for sharing.
